(19) United States
(12) Patent Application Publication
(10) Pub. No.: US 2026/0054282 A1
(43) Pub. Date: Feb. 26, 2026

(54) SYSTEM AND PROCESS FOR APPLYING GLUE

(71) Applicant: FIRST QUALITY BABY PRODUCTS, LLC, Great Neck, NY (US)

(72) Inventors: Pierluigi Cappellini, Bellefonte, PA (US); Joshua Alan Bubb, Antes Fort, PA (US)

(21) Appl. No.: 19/305,459

(22) Filed: Aug. 20, 2025

Related U.S. Application Data
(60) Provisional application No. 63/685,896, filed on Aug. 22, 2024.

(51) Int. Cl. B05B 12/16; B05B 1/02

(52) U.S. Cl. CPC B05B 12/16; B05B 1/02

(57) ABSTRACT

A glue application system including a glue application assembly and a vision system. The vision system includes cameras configured to capture images of a glue spray pattern and a substrate as illuminated by one or more lights sources, and one or more computer processors configured to generate vision data based on the captured images, the vision data indicating edges of the glue spray pattern and edges of the substrate, and adjust position of a glue head of the glue application assembly using one or more actuators so that the edges of the glue spray pattern are aligned with the edges of the substrate.

### RELATED APPLICAIONS

This application claims priority to and the benefit of U.S. Provisional Patent Application 63/685,896, filed Aug. 22, 2024 and entitled SYSTEM AND PROCESS FOR APPLYING GLUE, the contents of which are incorporated herein by reference in their entirety.

### FIELD OF THE INVENTION

The present invention generally relates to a system and process for applying glue, and in particular to the use of the system in a process for making hygienic absorbent articles.

### BACKGROUND

Diapers, training pants, briefs, sanitary pads and pantiliners have been made and sold for many years. In general, these products prevent accidental contact with body fluids or feces. The products typically include an absorbent core to retain fluids. The cores frequently include absorbent material of wood pulp and/or superabsorbent polymer particles. Wings are sometimes attached to sanitary pads or pantiliners and use to wrap around and attach to an undergarment. Similarly, side panels may be attached to diaper, training pants or briefs so that a back portion may be attached to a front portion to create a closed product. The wings and side panels are typically attached via glue or ultrasonic bonding. When glue is used, the glue is applied through a transfer roll or sprayed through ports in a glue head. Glue heads are available for example through Nordson Corporation (Westlake, Ohio, USA). The glue heads typically are stationary, but glue heads that move in the x and y direction are also known. Forced air may be used to spread a glue pattern on a material to be attached.

When attaching materials with glue in absorbent articles, it is important for the glue to be co-extensive with a width of the material to which it is applied. If the glue is not co-extensive, portions of the materials being attached might fold over or not attach to each other. This may lead to one material easily detaching from the other when stressed during use. An example of this would be when pulling a side panel of a diaper to attach the back to the front, the region where the side panel is attached to a backsheet may separate. Although glue heads are typically set in line to apply glue across a material, the width of the material sometimes varies, which may lead to the glue pattern being too narrow (the glue pattern does not extend the full width of the material) or too wide (glue spreads beyond the width of the material).

The process of making absorbent articles moves very fast and much of the process is not visible to the naked eye. Manufacturers have found that vision equipment, such as cameras may be placed on areas of the manufacturing line and project images on monitors. This enables machine operators to see in real time how the operations are working. Camera equipment is available through, for example AccuSentry Inc. (Marietta, Georgia, USA) and Cognex Corporation (Natick, Massachusetts, USA) and is known to enable monitoring of cutting operations as well as others.

There is a need for a system and process for applying glue and correcting for variability in the process.

### SUMMARY OF THE INVENTION

The present invention includes a rotating and translating adaptive glue head that is useful for applying glue on a surface to be attached as part of an absorbent article. The glue head is positioned relative to the surface via a bracket or the like. The glue head typically includes several nozzles spaced laterally across a width of the glue head. Melted glue flows through the nozzles and onto the surface to be attached. The glue head may rotate at +/−18 degrees relative to a transverse section across an absorbent article manufacturing line. The ability to rotate the glue head may be provided by a motor (for example a linear actuator) attached to a drive and bearings.

The glue head is typically oriented perpendicular to a path of material to be coated with adhesive. The width of the path is suitable for materials associated with absorbent articles, for example about 300 mm. As width of the material being coated varies during the process, the adhesive application may not be wide enough to cover the whole width or may be too wide and overspray the material. In order to correct for these problems, a camera may be placed adjacent to or above the glue or adhesive application area and the pattern may be monitored. The camera may be attached to a control system such that a signal is sent to the motor controlling the angle of the glue head and the orientation of the glue head may be adjusted anywhere between +/−18 degrees relative to its original position. This results in the glue pattern being coextensive with the width of the material to which it is applied.

A glue application system according to an exemplary embodiment of the present invention comprises: (A) a glue application assembly comprising: (1) a glue applicator comprising a glue head configured to apply a glue spray pattern to a substrate traveling in a machine direction of a manufacturing process line; (2) one or more actuators configured to move the glue head in translation along a cross direction that is perpendicular to the machine direction and in rotation relative to the cross direction; (B) a vision system comprising: (1) one or more computer processors operatively connected to the one or more actuators; (2) one or more cameras operatively connected to the one or more computer processors; and (3) one or more light sources operatively connected to the one or more computer processors, the one or more cameras configured to capture images of the glue spray pattern and the substrate as illuminated by the one or more lights sources, and the one or more computer processors being configured to: generate vision data based on the captured images, the vision data indicating edges of the glue spray pattern and edges of the substrate; and adjust position of the glue head using the one or more actuators so that the edges of the glue spray pattern are aligned with the edges of the substrate.

In an exemplary embodiment, the one or more computer processors are configured to narrow the glue spray pattern by using the one or more actuators to rotate the glue head.

In an exemplary embodiment, the one or more computer processors are configured to adjust the position of the glue head so that the position aligns with a center of the manufacturing process line by using the one or more actuators to translate the glue head.

In an exemplary embodiment, the substrate is a component of an absorbent article and the manufacturing process line is an absorbent article manufacturing process line.

In an exemplary embodiment, the one or more computer processors are part of a programmable logic controller.

### BRIEF DESCRIPTION OF THE DRAWINGS

FIG. 1 is a perspective view of a glue application system according to an exemplary embodiment of the present invention;

FIG. 2 is a front view of a glue application system according to an exemplary embodiment of the present invention;

FIG. 3 is a partial side view of a glue application system according to an exemplary embodiment of the present invention;

FIG. 4 is a perspective view of a glue head assembly according to an exemplary embodiment of the present invention;

FIGS. 5A-5C are top views of a glue head assembly showing cross direction motion and rotational motion of the glue head assembly relative to a substrate according to an exemplary embodiment of the present invention;

FIG. 6 is a diagram showing rotation of a glue head relative to a substrate according to an exemplary embodiment of the present invention;

FIG. 7 is a side view of a glue application system according to an exemplary embodiment of the present invention;

FIG. 8 is a process flow for controlling glue head cross-direction position according to an exemplary embodiment of the present invention;

FIG. 9 is a process flow for controlling glue head rotation according to an exemplary embodiment of the present invention; and

FIG. 10 is a photograph showing a glue spray pattern on a substrate.

### DETAILED DESCRIPTION OF PREFERRED EMBODIMENTS

In exemplary embodiments, the material to be coated with adhesive may be a backsheet of an absorbent article. Backsheets are materials that generally are liquid impermeable but may be moisture vapor permeable (breathable). Backsheets are used in absorbent products on a surface of the product that is distal to the user's body. The backsheet can be made of any known or otherwise effective backsheet material, provided that the backsheet prevents external leakage of exudates absorbed and contained in the protective underwear. Flexible materials suitable for use as the backsheet include, but are not limited to, woven and nonwoven materials, laminated tissue, polymeric films such as thermoplastic films of polyethylene and/or polypropylene, microporous films, composite materials such as a film-coated nonwoven material, or combinations thereof, as is well known in the art of making absorbent products, such as sanitary napkins, pantiliners, incontinence pads, and the like.

Nonwoven materials and processes for making them are generally known in the art. Generally, processes for making nonwoven materials include two steps: depositing and accumulating fibers to the desired basis weight onto a forming surface, and consolidating and bonding the accumulated fibers to form a coherent web. The first step may include, for example, spunlaying, meltblowing, carding, airlaying, wetlaying, coforming and combinations thereof. The bonding step may include, for example, hydroentanglement, cold calendering, hot calendering, through air thermal bonding, chemical bonding, needle punching, and combinations thereof.

In embodiments, the nonwoven material may be a laminate. The laminate may include spunbond layer(s) (S), and/or meltblown layer(s)((M), and/or carded layer(s) (C). Suitable laminates include, but are not limited to, SS, SSS, SMS or SMMS. The nonwoven material may have a basis weight from about 5 to 100 gsm, or from about 8 to 40 gsm, or from about 8 to 30 gsm. Woven or nonwoven materials may include natural fibers or synthetic fibers or combinations thereof.

An upper surface of the material is coated with an adhesive. Suitable adhesives include, but are not limited to hot melt adhesives, emulsion adhesives and the like. Dispomelt® and Technomelt® are examples of suitable adhesives available through Henkel AG & Company, KGaA (Düsseldorf, Germany). The adhesive may be applied by using the glue head in accordance with exemplary embodiments of the present invention. The amount of adhesive applied to the material may range from about 1.5 g/m² to about 20 g/m².

The adhesive or glue coated materials may be useful for diapers, training pants, youth pants, briefs, sanitary pads, bladder control pads and the like. In use, absorbent cores or absorbent systems are placed on a top surface of the adhesive coated material and elastic side panels are attached along lateral edges of the adhesive coated material.

In embodiments, a topsheet or cover may be placed on top of the absorbent core or absorbent system and attached to the core and backsheet with adhesive, ultrasonic bonding or combinations thereof, forming a chassis. Suitable topsheets are compliant, soft feeling, and non-irritating to the body of the wearer. Suitable topsheet materials include a liquid pervious material that is oriented towards and contacts the body of the wearer, thereby permitting body discharges to rapidly penetrate through the topsheet without allowing fluid to flow back through the topsheet to the skin of the wearer. A suitable topsheet can be made of various materials, such as woven and nonwoven materials; apertured film materials including apertured formed thermoplastic films, apertured plastic films, and fiber-entangled apertured films; hydro-formed thermoplastic films; porous foams; reticulated foams; reticulated thermoplastic films; thermoplastic scrims; or combinations thereof, as is well known in the art of making absorbent products such as sanitary napkins, pantiliners, incontinence pads, protective and the like.

Elastic side panels may be attached to the chassis to form diapers or adult protective underwear. Any elastic side panel known in the art of absorbent articles may be useful. Suitable elastic side panels include laminates of elastic films with nonwovens, laminates of elastic strands with nonwovens and the like. The elastic panels may be attached to the chassis by adhesive, ultrasonic bonding or a combination thereof. The length, width and shape of the side panels may be designed to make products of different sizes. Products with side panels may have a more underwear like appearance.

In embodiments, the side panels are attached to the core. A portion of each side panel is left unattached to form leg openings. The side panels may be attached to the chassis with glue, adhesive, ultrasonic bonding or combinations thereof. The side panels may be attached to the chassis at various angles to create a more garment like fit.

As is known in the art, hooks and loops may be used on articles of the present invention. Nonwoven materials may function as the loops.

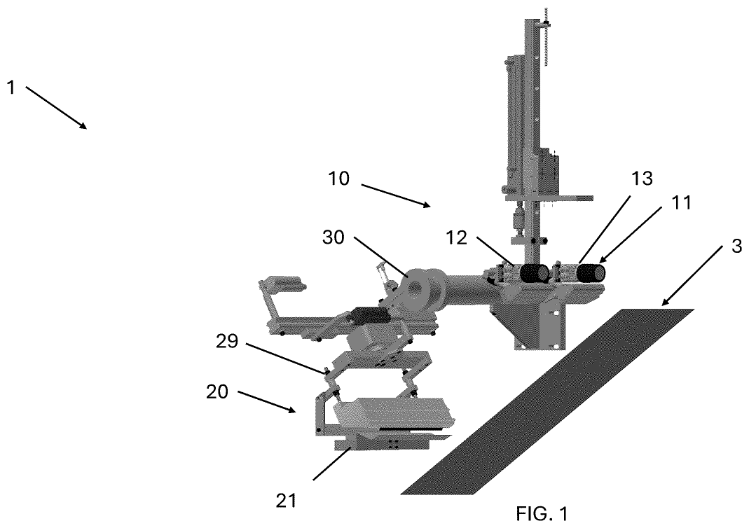

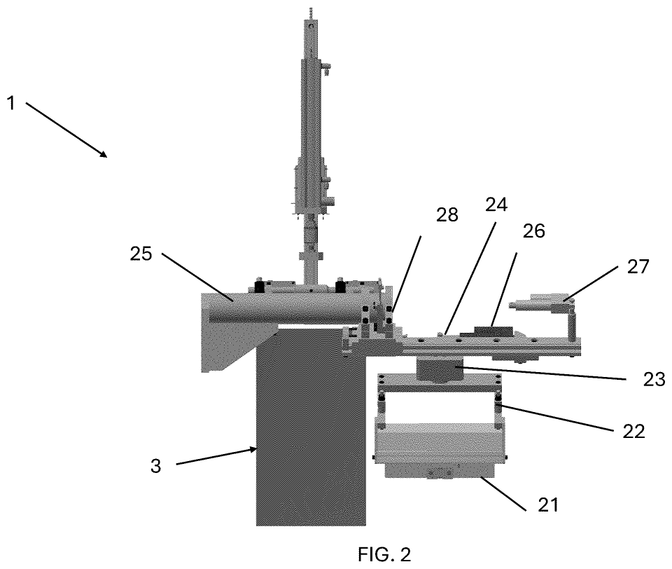

FIGS. 1 and 2 show a glue application system, generally designated by reference number 1, according to an exemplary embodiment of the present invention. The glue application system 1 includes a vision system assembly 10 and a glue head assembly 20. The glue head assembly 20 includes a glue head 21, such as, for example, a Nordson AltaSpray™-c Applicator glue head or any other suitable glue head. The glue head 21 is attached to a bracket 22 and suspended over an absorbent product manufacturing line 3. The bracket 22 holding the glue head 21 is in turn attached to a pivot mount 23 that utilizes bearings and/or bushings that enable the glue head 21 to rotate relative to perpendicular with a machine direction of the manufacturing line. In exemplary embodiments, the glue head 21 may be pivoted within an angular range relative to perpendicular with a machine direction of the manufacturing line, such as, for example, within a range of +18 degrees and −18 degrees.

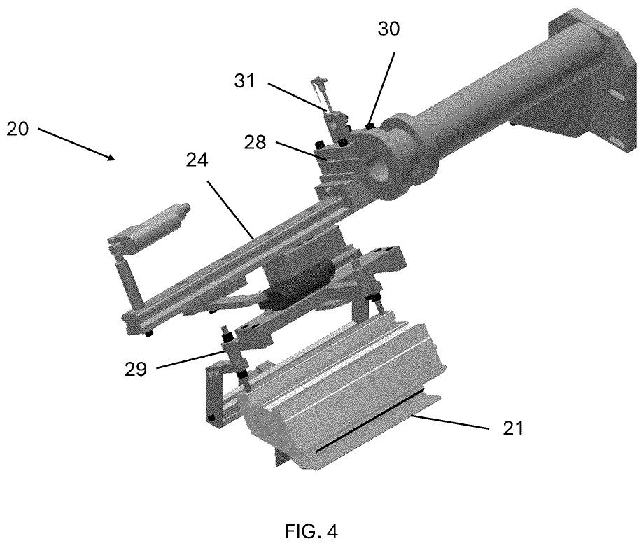

The pivot mount 23 is attached to a linear carriage and guide rail assembly made up of a rail 24 and a carriage 28. The carriage 28 is fixedly mounted to a main mounting support 25, and the rail 24 is moveably mounted to the carriage 28 so that the rail 24 is moveable in translation relative to the carriage 28. The carriage 28 has rolling elements, such as, for example, ball bearings or cylindrical roller bearings, that enable lateral motion of the rail 24 and glue head assembly 20. Actuators 26, 27, such as, for example, feedback linear actuators, may be mounted on the rail 24. One actuator (angle actuator 26) enables the glue head 21 to pivot/rotate. The other actuator (cross direction actuator 27) enables the glue head 21 to move laterally (in the cross direction) to adjust the adhesive pattern. As shown in FIG. 4, a locking element 31, such as a pin lock, may be used to lock the carriage 28 in place.

As further shown in FIG. 4, the glue head assembly 20 further includes threaded rods 29 that allow for adjustment of the distance of the glue head 21 from the manufacturing line 3 and a pivoting element 30 for vertical pivotal adjustment of the glue head 21 relative to the manufacturing line 3. FIG. 4 shows the adhesive applicator disengaged from a normal glue application position and slid outwards for maintenance.

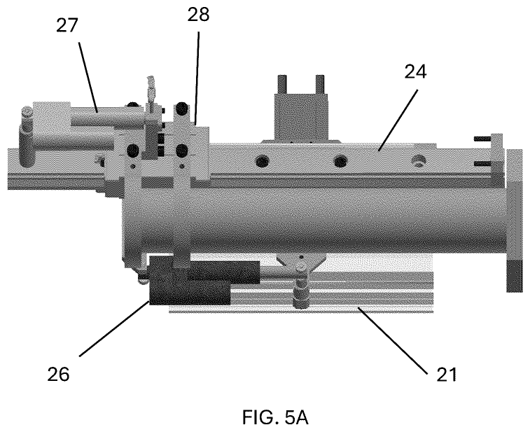

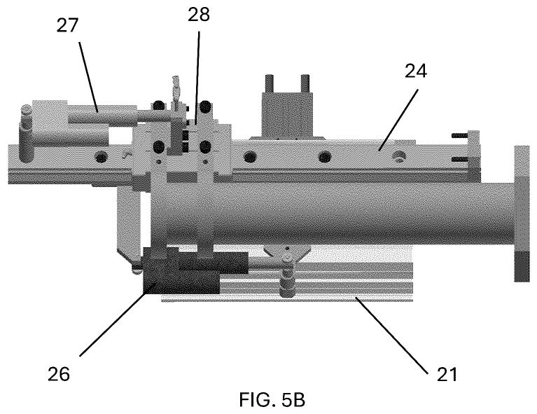

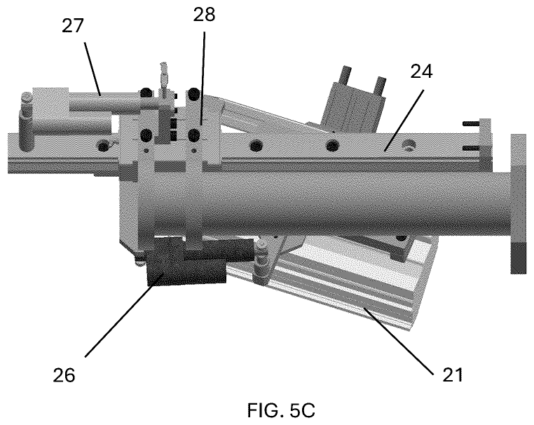

FIG. 5A-5C show the glue head assembly 10 at various positions depending on the stroke position of the actuators 26, 27. FIG. 5A shows the cross direction actuator 27 at zero stroke so that the glue head 21 is over-positioned towards the drive side of the process and the angle actuator 26 at full stroke so that the glue head 21 is perpendicular to the process center line and therefore providing the widest width of glue application. FIG. 5B shows the cross direction actuator 27 at full stroke so that the glue head 21 is over-positioned towards the operator side of the process and the angle actuator 26 still at full stroke. FIG. 5C shows the cross direction actuator 27 at half stroke and the angle actuator 26 at zero stroke (fully closed) so that the glue head 21 is at a maximum angle relative to the process center line and therefore providing the narrowest width of glue application.

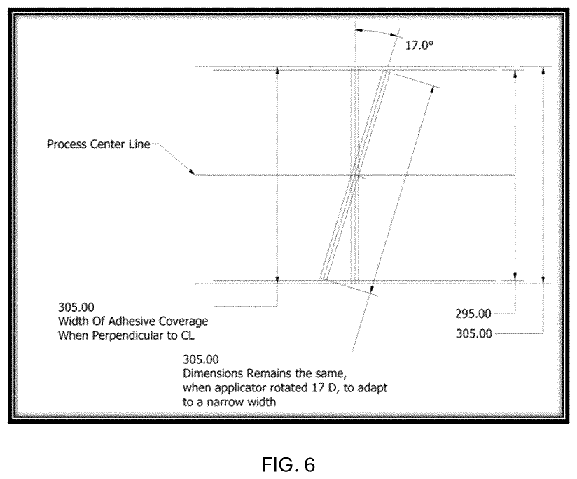

FIG. 6 shows variation of the angle of the glue head 21 to accommodate varying widths of the substrate. When the glue head 21 is perpendicular to the process center line, the glue application width is at a maximum, which in this case is 305 mm, to accommodate the substrate having the same width. When the substrate is reduced in width to 295 mm, the glue head is angled to reduce the width of the glue application to accommodate the reduced width of the substrate. In this example, the glue head is angled 17 degrees relative to a line perpendicular to the process center line.

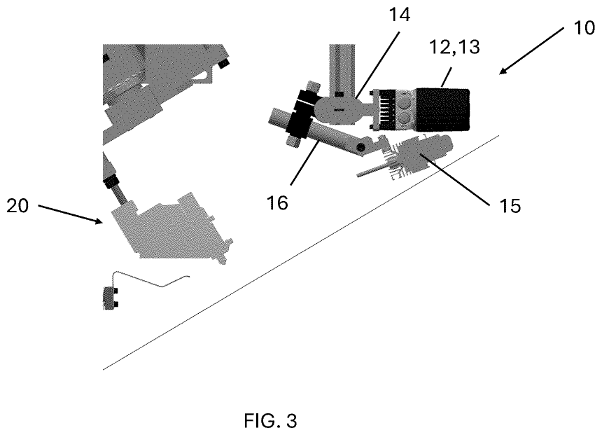

The vision system assembly 10 includes a vision system, generally designated by reference number 11. As shown in FIG. 3, the vision system 10 is made up of cameras 12, 13, which are both attached to a camera bracket 14. In exemplary embodiments, the cameras 12, 13 may be smart cameras, a specific example being an In-Sight 9902L 2K line scan smart camera. The vision system 11 further includes a light source 15, which is mounted to a light source bracket 16. In exemplary embodiments, the light source 15 may be a fluorescent, quartz halogen, or LED light source. In a specific example, the light source is LED lighting available from Advanced Illumination (440 State Garage Rd, Rochester, Vermont, USA).

The vision system 11 further includes a programmable logic controller (PLC), which may be, for example, 1769-L18ER-BB1B Version 33.014 (Allen-Bradley, Milwaukee, Wisconsin, USA). The PLC is configured to analyze the camera data and determine actuator position.

The vision system 11 further includes a human-machine interface (HMI), which may be, for example, PanelView Plus 1000 (Allen-Bradley, Milwaukee, Wisconsin, USA). The HMI is configured to both manually control and automate the actuators. In manual mode, the operators have full control of both actuators to move them in the cross direction and control the width. In automatic mode, the PLC uses the vision inspection to determine where the glue head should be and how wide the glue spray should be. The HMI uses the PLC to communicate with other components of the vision system 11.

In exemplary embodiments of the present invention, the actuators 26, 27 are DC driven linear actuators with potentiometer feedback. The feedback provided allows the PLC to know the precise location of the actuators, allowing for full control of the position of both actuators. The PLC controls the actuators by monitoring this feedback and providing +/−24v DC through relays to position them. A suitable example of an actuator useable with the present invention is Progressive Automations PA-14P-2-150 (Richmond, British Columbia, Canada).

In general, the vision system 11 incorporates a non-transitory computer readable medium having stored thereon instructions that may be carried out by a computer processor to perform the processes described herein.

In exemplary embodiments, the light source 15 is oriented towards the surface of substrate (e.g., film or other material) to which glue or adhesive is applied. The camera bracket 14 is adjustable such that the angle of the cameras 12, 13 relative to the surface of the adhesive coated substrate may be adjusted. In this regard, the angle of the cameras 12, 13 may be adjusted to within a range of from about 20 to about 45 degrees. The cameras are operatively connected to a monitor (not shown) which is conveniently placed for a machine operator to monitor glue application. The monitor is configured to allow an operator to view the glue pattern and to also visualize the inspection. The cameras 12, 13, monitor and glue head 21 are operatively connected to the PLC. As explained in more detail below, the PLC tracks adhesive or glue application patterns, detects overspray or undercoating and sends a signal to the actuators 26, 27, thereby adjusting the angle and cross direction location of the glue head 21 relative to the substrate edges to obtain full adhesive coverage.

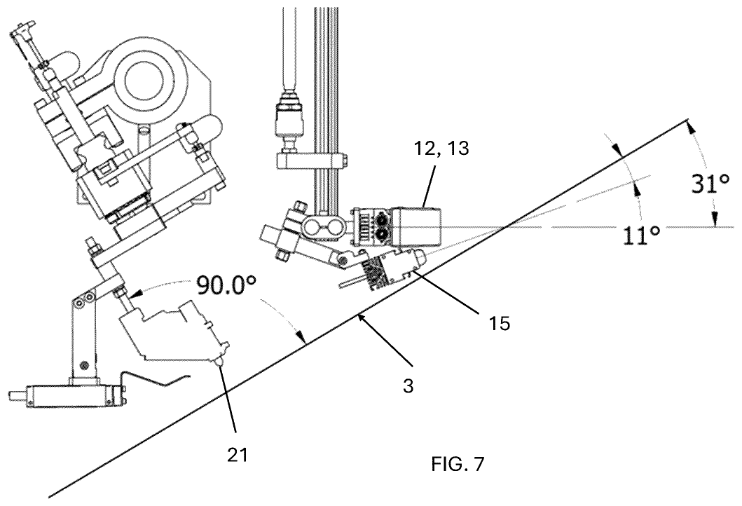

In an exemplary embodiment, as shown in FIG. 7, the angle of the glue head relative to the upper surface of the substrate (and the upper surface of the conveyor and conveyor belt) may be varied between 0 degrees and 90 degrees. In an exemplary embodiment, the angle of the optical axis of the cameras 12, 13 relative to the bottom surface of the substrate (and the bottom surface of the conveyor and conveyor belt) may be varied between 0 degrees and 11 degrees. In an exemplary embodiment, the angle of the direction of light emitted by the light source 15 relative to the bottom surface of the substrate (and the bottom surface of the conveyor and conveyor belt) may be varied between 0 degrees and 31 degrees. It should be appreciated that the present invention is not limited to these angle ranges.

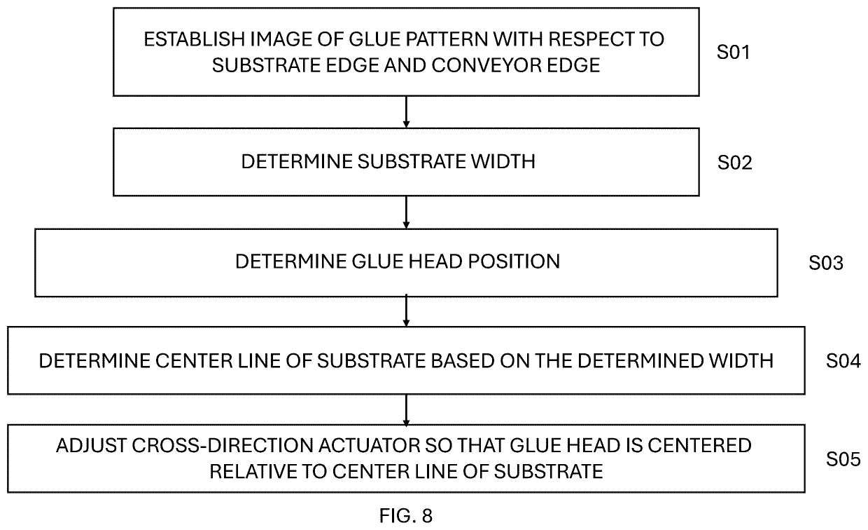

FIG. 8 shows a process flow for cross-direction inspection and control of glue application in accordance with exemplary embodiments of the present invention. In step S01 of the process, the cameras 12, 13 and the light source 15 are used to establish a definitive image of the glue pattern with respect to the substrate edge and the edge of the conveyor. The vision system 11 performs an inspection to measure the substrate edge with respect to the conveyor edge (which is fixed and known) to obtain the substrate width and width variations as the substrate is moved by the conveyor. Specifically, in step S02, the substrate edges are identified using known vision techniques, such as, for example, a combination of binarized filters and edge find algorithms. In step S03, using the fixed conveyor edges as a reference, the vision system 11 finds the substrate edges to obtain a measurement from the substrate edges to the conveyor edges and feeds that information back to the PLC for further logic to determine glue head position. Once the substrate width is calculated in the PLC, the substrate centerline is determined in step S04. In step S05, the cross direction actuator 27 is adjusted accordingly to ensure the glue head 21 remains centered with respect to the centerline of the substrate.

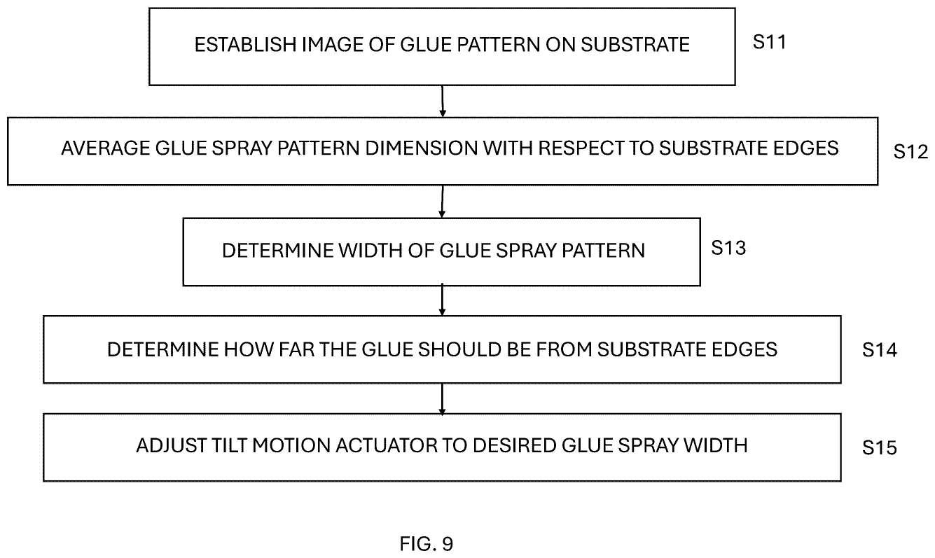

FIG. 9 shows a process flow for inspection and rotational control of glue application in accordance with exemplary embodiments of the present invention. In step S11 of the process, the cameras 12, 13 and the light source 15 are used to establish a definitive image of the glue pattern on the substrate. In step S12, the vision system 11 performs an inspection to average the glue spray pattern dimension with respect to the substrate edges using edge magnitude filtering followed by binarized filtering of the magnitude filtering output. This information is then fed to the PLC where logic is used to determine the width of the glue spray pattern (step S13). The process then continues to step S14, where it is determined using fixed parameters how far the glue should be from the substrate edges. The determined distance in step S14 is then used in step S15 to control the tilt motion actuator 26 to rotate the glue head to the desired spray width.

In exemplary embodiments, the effective width of the glue head (i.e., the width of the glue pattern) can be adjusted within a range of 295 mm to 305 mm and the cross-direction position of the glue head can be adjusted +/−25 mm.

The processes described above may be most useful when a tight tolerance of bonding materials is desired, especially when employing an adhesive arrangement such as a spray system, where outermost edges can be undefined.

The systems and processes described herein are advantageous in the case of varying substrate widths, for example, during transition from a full size roll of material throughout the runout time.

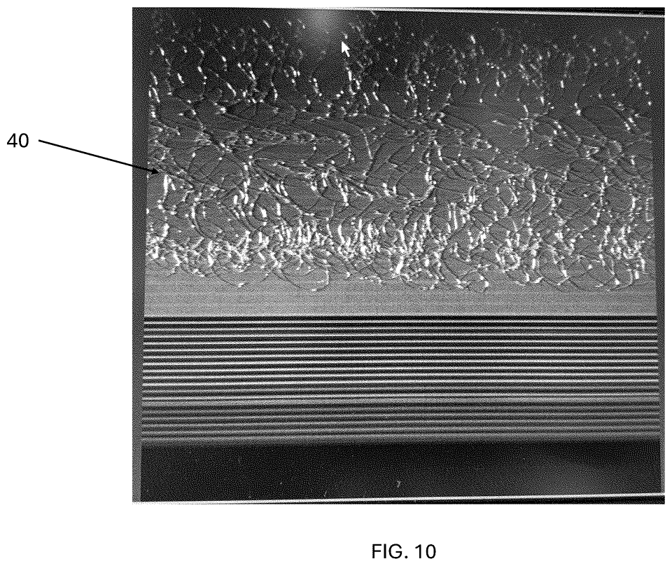

FIG. 10 shows width variation of the glue application 40 monitored by web edge sensors. An example of a suitable sensor useable with the present invention is an infrared sensor, such as, for example, FIFE DSE-17 Digital Wideband Infrared Sensor (Maxcess, 222 W Memorial Rd, Oklahoma City, Oklahoma, USA), or an opto-electronic sensor, such as, for example, SICK AS30 Array Sensor (SICK AG, Waldkirch, Germany). Along with monitoring web width, the sensors may track web location in comparison to the machine center line. As is known in the industry, for example, the FIFE steering device, monitors and tracks the web as required by the process.

### EXAMPLE 1

In normal run, the material has a nominal width of 300 mm but as the material approaches the core, the material necks down to 295 mm. The camera system monitors this width and feeds that data to the PLC. The PLC then determines that the glue pattern also needs to narrow by 5 mm. The PLC then communicates with the actuators to rotate the glue applicator to achieve the desired narrowed glue application pattern.

### EXAMPLE 2

In normal run, the glue spray pattern is 300 mm nominally but wear of the glue tips causes overspray, which in turn results in the glue pattern getting wider. The camera system identifies this change and adjusts the width of the glue head accordingly, for example, by adjusting the angle of the glue head relative to the process center line.

### EXAMPLE 3

In normal run, the material is ran on a strict process centerline. As components wear or get dirty the material strays off the centerline. The camera system determines web position and then the PLC moves the cross-direction actuator to maintain the glue head on the material centerline.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. A glue application system, comprising:
(A) a glue application assembly comprising:
(1) a glue applicator comprising a glue head configured to apply a glue spray pattern to a substrate traveling in a machine direction of a manufacturing process line;
(2) one or more actuators configured to move the glue head in translation along a cross direction that is perpendicular to the machine direction and in rotation relative to the cross direction;
(B) a vision system comprising:
(1) one or more computer processors operatively connected to the one or more actuators;
(2) one or more cameras operatively connected to the one or more computer processors; and
(3) one or more light sources operatively connected to the one or more computer processors,
the one or more cameras configured to capture images of the glue spray pattern and the substrate as illuminated by the one or more lights sources, and
the one or more computer processors being configured to:
generate vision data based on the captured images, the vision data indicating edges of the glue spray pattern and edges of the substrate; and
adjust position of the glue head using the one or more actuators so that the edges of the glue spray pattern are aligned with the edges of the substrate.

2. The glue application system of claim 1, wherein the one or more computer processors are configured to narrow the glue spray pattern by using the one or more actuators to rotate the glue head.

3. The glue application system of claim 1, wherein the one or more computer processors are configured to adjust the position of the glue head so that the position aligns with a center of the manufacturing process line by using the one or more actuators to translate the glue head.

4. The glue application system of claim 1, wherein the substrate is a component of an absorbent article and the manufacturing process line is an absorbent article manufacturing process line.

5. The glue application system of claim 1, wherein the one or more computer processors are part of a programmatic logic controller.
